(19) United States
(12) Patent Application Publication
(10) Pub. No.: US 2023/0401998 A1
(43) Pub. Date: Dec. 14, 2023

(54) DISPLAY DEVICE

(71) Applicant: Samsung Display Co., Ltd., Yongin-si (KR)

(72) Inventors: JONGWOON KIM, Hwaseong-si (KR); HYUN-SIK YOON, Asan-si (KR); KIHYUN SUNG, Suwon-si (KR); KIHONG SONG, Seoul (KR)

(21) Appl. No.: 18/130,691

(22) Filed: Apr. 4, 2023

(30) Foreign Application Priority Data
Jun. 9, 2022 (KR) 10-2022-0070066

(51) Int. Cl. G09G 3/32

(52) U.S. Cl. CPC G09G 3/32; G09G 2310/08; G09G 2320/043; G09G 2320/0257; G09G 2310/0275; G09G 2310/0267; G09G 2300/0842

(57) ABSTRACT

A display device includes a display panel including a plurality of pixels, and an image sticking compensator for generating age data with respect to the plurality of pixels by accumulating average degradation data that is an average of degradation data with respect to a plurality of successive frame periods, by accumulating the degradation data with respect to a representative frame period among the plurality of successive frame periods, or by accumulating degradation data generated by accumulating degradation differential data with respect to two successive frame periods, and generating output image data by compensating input image data using the age data.

This application claims priority to Korean Patent Application No. 10-2022-0070066 filed on Jun. 9, 2022 and all the benefits accruing therefrom under 35 U.S.C. § 119, the content of which in its entirety is herein incorporated by reference.

### BACKGROUND

### 1. Field

Embodiments relate to a display device applied to various electronic apparatuses.

### 2. Description of the Related Art

A display device may include a plurality of pixels for displaying an image. The pixel may include transistors such as a driving transistor or the like and a light emitting element. When the display device is used, degradation of the driving transistor and/or the light emitting element (degradation of the pixel) may occur.

When the pixels are degraded, the display device may not display an image having a desired luminance, and an image sticking may be generated in the display device.

### SUMMARY

Accordingly, the display device may calculate age data with respect to the pixels using an image sticking compensation method, and may improve the image sticking of the display device by compensating degradation of the pixels based on the age data. Embodiments provide a display device that accurately calculates age data with respect to pixels to improve image sticking.

A display device according to embodiments includes: a display panel including a plurality of pixels, and an image sticking compensator for generating age data with respect to the plurality of pixels by accumulating average degradation data that is an average of degradation data with respect to a plurality of successive frame periods and generating output image data by compensating input image data using the age data.

In an embodiment, the plurality of successive frame periods may include active frame periods displaying an active image and black frame periods alternating with the active frame periods and displaying a black image.

In an embodiment, the plurality of successive frame periods may include an even number of frame periods.

In an embodiment, the image sticking compensator may include a degradation data calculator for calculating the degradation data with respect to the plurality of successive frame periods based on the input image data, an average degradation data calculator for calculating the average degradation data based on the degradation data, an age data calculator for calculating the age data by accumulating the average degradation data, an internal age memory for storing the age data, and a data compensator for compensating the input image data using the age data.

In an embodiment, the display device may further include a gate driver for providing gate signals to the plurality of pixels, a data driver for providing data signals generated based on the output image data to the plurality of pixels, and a timing controller for controlling the gate driver and the data driver. The timing controller may include the image sticking compensator.

In an embodiment, the display device may further include an external memory for storing the age data during a power-off of the display device.

A display device according to embodiments includes: a display panel including a plurality of pixels, and an image sticking compensator for generating age data with respect to the plurality of pixels by accumulating degradation data with respect to a representative frame period among a plurality of successive frame periods, and for generating output image data by compensating input image data using the age data.

In an embodiment, the representative frame period may be randomly selected.

In an embodiment, the representative frame period may be selected in a predetermined order.

In an embodiment, the plurality of successive frame periods may include active frame periods displaying an active image and black frame periods alternating with the active frame periods and displaying a black image.

In an embodiment, the plurality of successive frame periods may include an even number of frame periods.

In an embodiment, the image sticking compensator may include a degradation data calculator for calculating the degradation data with respect to the representative frame period based on the input image data, an age data calculator for calculating the age data by accumulating the degradation data, an internal age memory for storing the age data, and a data compensator for compensating the input image data using the age data.

In an embodiment, the display device may further include a gate driver for providing gate signals to the plurality of pixels, a data driver for providing data signals generated based on the output image data to the plurality of pixels, and a timing controller for controlling the gate driver and the data driver. The timing controller may include the image sticking compensator.

In an embodiment, the display device may further include an external memory for storing the age data during a power-off of the display device.

A display device according to embodiments includes: a display panel including a plurality of pixels, and an image sticking compensator for generating degradation data by accumulating degradation differential data with respect to two successive frame periods, for generating age data with respect to the plurality of pixels by accumulating the degradation data, and for generating output image data by compensating input image data using the age data.

In an embodiment, the image sticking compensator may include a degradation differential data calculator for calculating the degradation differential data based on the input image data, a degradation data calculator for calculating the degradation data by accumulating the degradation differential data, an age data calculator for calculating the age data by accumulating the degradation data, an internal age memory for storing the age data, and a data compensator for compensating the input image data using the age data.

In an embodiment, the degradation differential data calculator calculates the degradation differential data based on a difference between the input image data in a first frame period of the two successive frame periods and the input image data in a second frame period of the two successive frame periods.

In an embodiment, the degradation data calculator calculates the degradation data with respect to the second frame period by adding the degradation differential data to the degradation data with respect to the first frame period.

In an embodiment, the display device may further include a gate driver for providing gate signals to the plurality of pixels, a data driver for providing data signals generated based on the output image data to the plurality of pixels, and a timing controller for controlling the gate driver and the data driver. The timing controller may include the image sticking compensator.

In an embodiment, the display device may further include an external memory for storing the age data during a power-off of the display device.

In the display device according to the embodiments, the age data with respect to the pixels may be generated by accumulating the average of the degradation data with respect to the plurality of successive frame periods, by accumulating the degradation data with respect to the representative frame period among the plurality of successive frame periods, or by accumulating the degradation differential data with respect to two successive frame periods, so that the age data may be accurately calculated using relatively small amount of degradation data, and the image sticking of the display device due to degradation of the pixels may be effectively improved.

### BRIEF DESCRIPTION OF THE DRAWINGS

Illustrative, non-limiting embodiments will be more clearly understood from the following detailed description taken in conjunction with the accompanying drawings.

FIG. 1 is a block diagram illustrating a display device according to an embodiment.

FIG. 2 is a circuit diagram illustrating a pixel included in the display device in FIG. 1.

FIG. 3 is a diagram for describing images displayed in frame periods according to an embodiment.

FIG. 4 is a block diagram illustrating an image sticking compensator according to an embodiment.

FIG. 5 is a diagram for describing an operation of the image sticking compensator in FIG. 4.

FIG. 6 is a block diagram illustrating an image sticking compensator according to another embodiment.

FIG. 7 is a diagram for describing an operation of the image sticking compensator in FIG. 6.

FIG. 8 is a diagram for describing images displayed in frame periods according to an embodiment.

FIG. 9 is a block diagram illustrating an image sticking compensator according to still another embodiment.

FIG. 10 is a block diagram illustrating an electronic apparatus including a display device according to an embodiment.

### DETAILED DESCRIPTION

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Hereinafter, a display device according to embodiments of the present disclosure will be described in more detail with reference to the accompanying drawings. The same or similar reference numerals will be used for the same elements in the accompanying drawings.

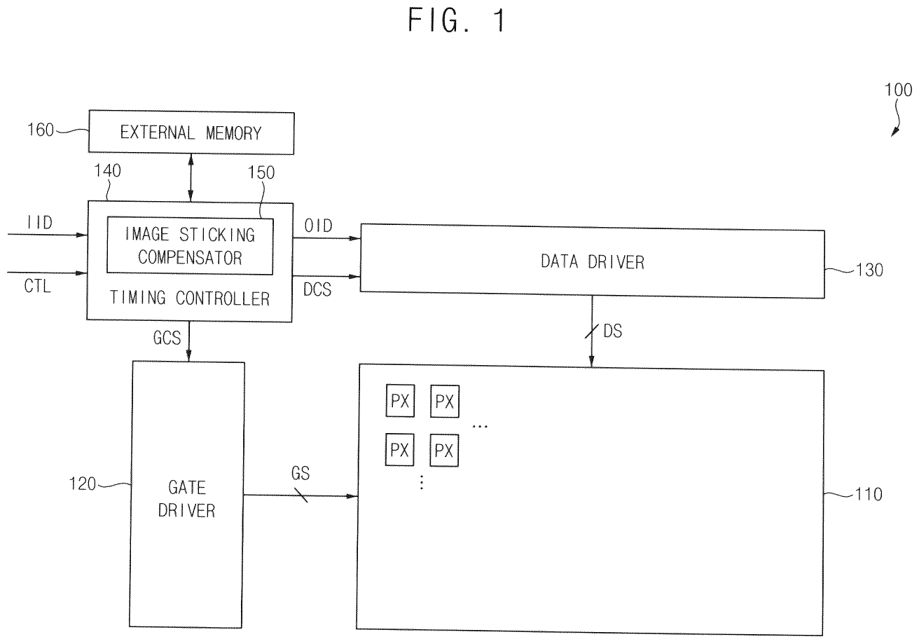

FIG. 1 is a block diagram illustrating a display device 100 according to an embodiment.

Referring to FIG. 1, the display device 100 may include a display panel 110, a gate driver 120, a data driver 130, a timing controller 140, an image sticking compensator 150, and an external memory 160.

The display panel 110 may include various display elements such as an organic light emitting diode (“OLED”) or the like. Hereinafter, the display panel 110 including the organic light emitting diode as a display element will be described for convenience. However, the present disclosure is not limited thereto, and the display panel 110 may include various display elements such as a liquid crystal display (“LCD”) element, an electrophoretic display (“EPD”) element, an inorganic light emitting diode, a quantum-dot light emitting diode (“QLED”), or the like in another embodiment.

The display panel 110 may include a plurality of pixels PX. The pixels PX may receive gate signals GS and data signals DS. The pixels PX may emit light based on the gate signals GS and the data signals DS. In an embodiment, the pixels PX may include red pixels, green pixels, and blue pixels.

The gate driver 120 may generate the gate signals GS based on gate control signals GCS, and may provide the gate signals GS to the pixels PX. In an embodiment, the gate control signals GCS may include a gate start signal, a gate clock signal, or the like.

The data driver 130 may generate the data signals DS based on output image data OID and data control signals DCS, and may provide the data signals DS to the pixels PX. In an embodiment, the data control signals DCS may include a data start signal, an output data enable signal, or the like.

The timing controller 140 may control a driving of the gate driver 120 and a driving of the data driver 130. The timing controller 140 may generate the output image data OID, the gate control signals GCS, and the data control signals DCS based on input image data IID and control signals CTL. The timing controller 140 may provide the gate control signals GCS to the gate driver 120, and may provide the output image data OID and the data control signals DCS to the data driver 130. In an embodiment, the input image data IID may include red image data, green image data, and blue image data. In an embodiment, the control signals CTL may include a vertical synchronization signal, a horizontal synchronization signal, an input data enable signal, a clock signal, or the like.

The image sticking compensator 150 may generate age data with respect to the pixels PX by accumulating degradation data generated based on the input image data IID, and may generate the output image data OID by compensating the input image data IID using the age data. FIG. 1 illustrates an embodiment in which the timing controller 140 includes the image sticking compensator 150, but the present disclosure is not limited thereto, and in another embodiment, the image sticking compensator 150 may be configured separately from the timing controller 140.

The external memory 160 may store the age data with respect to the pixels PX, and may maintain the stored age data during a power-off of the display device 100. In an embodiment, when the display device 100 is powered on, the image sticking compensator 150 may read the age data stored in the external memory 160. Further, the image sticking compensator 150 may periodically write the age data to the external memory 160. For example, the age data may be written to the external memory 160 every about 5 minutes to about 10 minutes, but the period of the write operation to the external memory 160 is not limited thereto. The display device 100 may use the external memory 160 to calculate and store the age data with respect to the pixels PX from after the display device 100 is manufactured to the present time. In an embodiment, the external memory 160 may be a non-volatile memory such as an embedded multimedia card (“eMMC”), a universal flash storage (“UFS”), or the like.

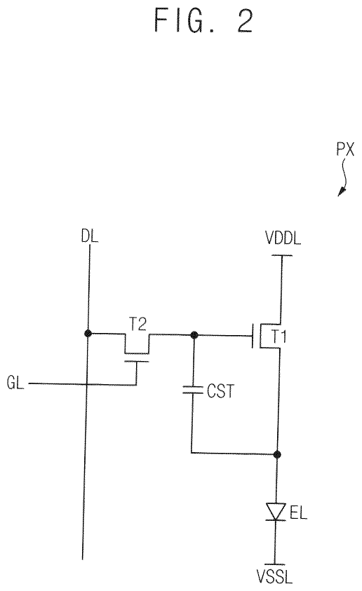

FIG. 2 is a circuit diagram illustrating the pixel PX included in the display device 100 in FIG. 1.

Referring to FIG. 2, the pixel PX may include a first transistor T1, a second transistor T2, a storage capacitor CST, and a light emitting element EL.

The first transistor T1 may provide a driving current to the light emitting element EL. A first electrode of the first transistor T1 may be connected to a first power line VDDL that transmits a first driving voltage, and a second electrode of the first transistor T1 may be connected to a first electrode of the light emitting element EL. A gate electrode of the first transistor T1 may be connected to a second electrode of the second transistor T2.

The second transistor T2 may provide the data signal DS to the gate electrode of the first transistor T1 in response to the gate signal GS. A first electrode of the second transistor T2 may be connected to a data line DL that transmits the data signal DS, and a second electrode of the second transistor T2 may be connected to the gate electrode of the first transistor T1. Agate electrode of the second transistor T2 may be connected to a gate line GL that transmits the gate signal GS.

FIG. 2 illustrates an embodiment in which each of the first transistor T1 and the second transistor T2 is an NMOS transistor, but the present disclosure is not limited thereto. In another embodiment, at least one of the first transistor T1 and the second transistor T2 may be a PMOS transistor.

The storage capacitor CST may maintain a voltage between the second electrode and the gate electrode of the first transistor T1. A first electrode of the storage capacitor CST may be connected to the gate electrode of the first transistor T1, and a second electrode of the storage capacitor CST may be connected to the second electrode of the first transistor T1.

FIG. 2 illustrates an embodiment in which the pixel PX includes two transistors and one capacitor, but the present disclosure is not limited thereto. In another embodiment, the pixel PX may include three or more transistors and/or two or more capacitors.

The light emitting element EL may emit light based on the driving current. A first electrode of the light emitting element EL may be connected to the second electrode of the first transistor T1, and a second electrode of the light emitting element EL may be connected to a second power line VSSL that transmits a second driving voltage. For example, the first driving voltage may be greater than the second driving voltage.

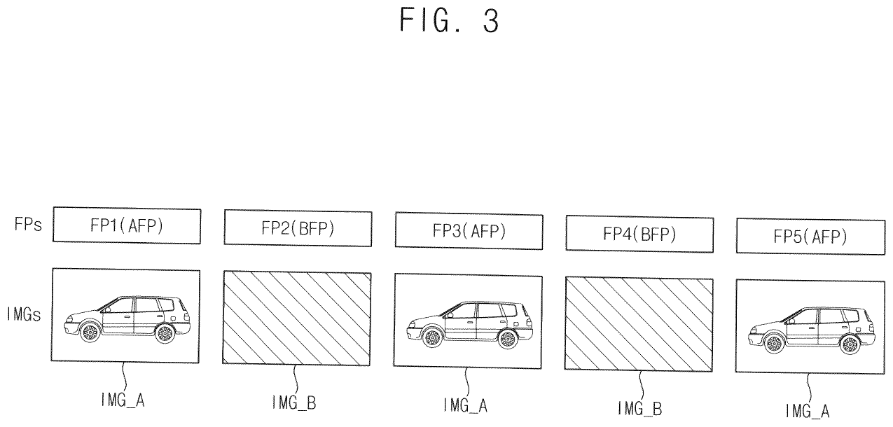

FIG. 3 is a diagram for describing images IMGs displayed in frame periods FPs according to an embodiment.

Referring to FIG. 3, an image display period of the display device 100 may include a plurality of successive frame periods FPs. In an embodiment, the successive frame periods FPs may include active frame periods AFP displaying an active image IMG_A and black frame periods BFP alternating with the active frame periods AFP and displaying a black image IMG_B. In other words, the display device 100 may be driven by a black frame insertion (“BFI”) method in which the black frame period BFP is inserted between adjacent active frame periods AFP. For example, as illustrated in FIG. 3, each of a first frame period FP1, a third frame period FP3, and a fifth frame period FP5 may be the active frame period AFP, and each of a second frame period FP2 and a fourth frame period FP4 may be the black frame period BFP. The active image IMG_A may be a normal image for providing visual information to a user, and the black image IMG_B may be a full black image for reducing a moving/motion picture response time (“MPRT”).

When the display device 100 displays a moving image, an image sticking may occur as the image displayed by the display device 100 changes. In order to reduce or remove such an image sticking, the black frame period BFP may be inserted between adjacent active frame periods AFP, and accordingly, the MPRT may be reduced.

When the successive frame periods FPs include the active frame periods AFP and the black frame periods BFP which are alternated, an image refresh rate of the display device 100 may decrease. For example, when a driving frequency of the display device 100 is 120 Hertz (Hz), as the black frame period BFP is inserted between adjacent active frame periods AFP, the image refresh rate of the display device 100 may be 60 Hz.

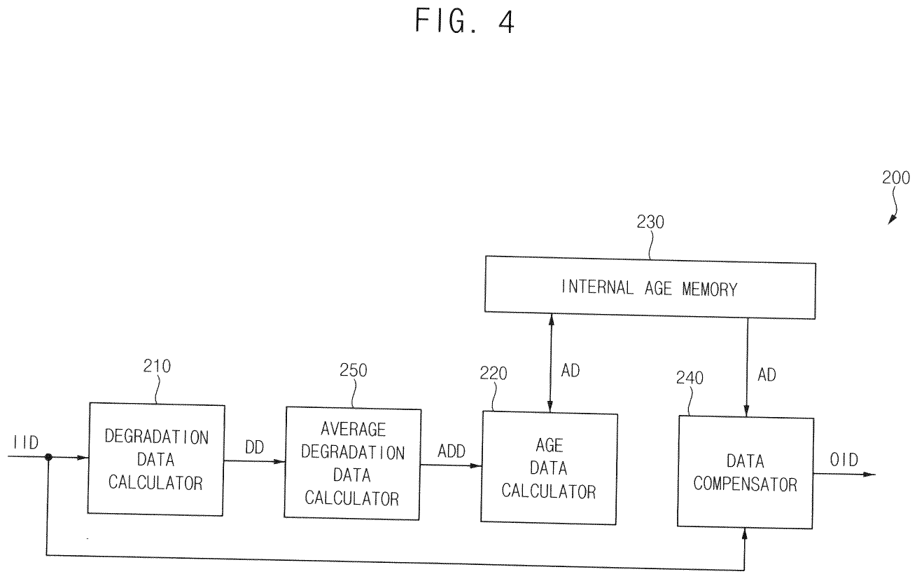

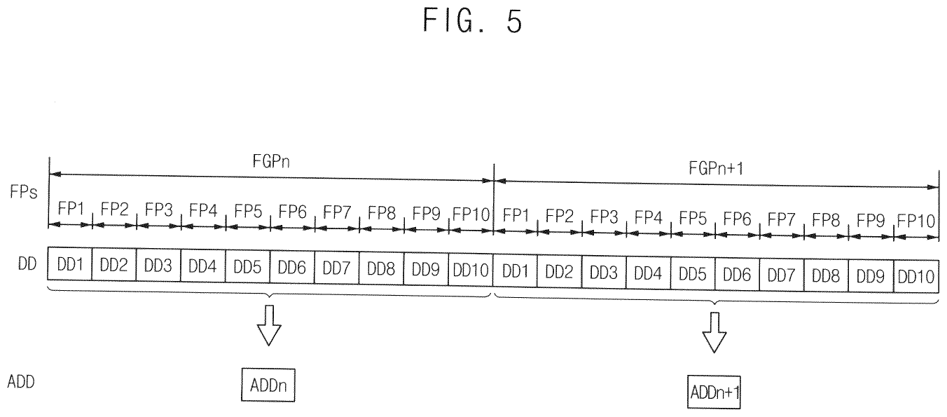

FIG. 4 is a block diagram illustrating an image sticking compensator 200 according to an embodiment. The image sticking compensator 200 in FIG. 4 may be an example of the image sticking compensator 150 included in the display device 100 in FIG. 1. FIG. 5 is a diagram for describing an operation of the image sticking compensator 200 in FIG. 4.

Referring to FIGS. 4 and 5, the image sticking compensator 200 may generate the age data AD with respect to the pixels PX by accumulating average degradation data ADD that is an average of degradation data DD with respect to the successive frame periods FPs, and may generate the output image data OID by compensating the input image data IID using the age data AD. The successive frame periods FPs may include an even number of frame periods FPs. FIG. 5 illustrates an embodiment in which the successive frame periods FPs include 10 frame periods FP1-FP10, but the present disclosure is not limited thereto, and in another embodiment, the successive frame periods FPs may include an even number of frame periods which is less than or greater than 10. The image sticking compensator 200 may include a degradation data calculator 210, an average degradation data calculator 250, an age data calculator 220, an internal age memory 230, and a data compensator 240.

The degradation data calculator 210 may calculate the degradation data DD with respect to the successive frame periods FPs based on the input image data IID. The degradation data DD may include degradation values with respect to the pixels PX. In an embodiment, the degradation data calculator 210 may calculate the degradation data DD with respect to each frame period by applying degradation weight data to the input image data IID.

The degradation weight data may be determined based on at least one of a temperature of the display device 100, a driving frequency of the display device 100, and positions of the pixels PX. For example, the degradation data calculator 210 may include a degradation weight lookup table that stores the degradation weight data.

The average degradation data calculator 250 may calculate the average degradation data ADD based on the degradation data DD with respect to the successive frame periods FPs. The average degradation data ADD may be an average of the degradation data DD with respect to the successive frame periods FPs. For example, the average degradation data ADD may include average degradation values with respect to the pixels PX, and the average degradation value with respect to each pixel PX may be an average of the degradation values of the frame periods PF1-FP10 with respect to each pixel PX. The average degradation data calculator 250 may include an internal degradation memory for storing the degradation data DD with respect to the successive frame periods FPs in order to calculate the average degradation data ADD.

In an embodiment, after an n^{th} frame group period FGPn including successive first to tenth frame periods FP1-FP10 ends, the average degradation data calculator 250 may calculate n^{th} average degradation data ADDn based on the degradation data DD1-DD10 with respect to the frame periods FP1-FP10 included in the n^{th} frame group period FGPn. Further, after an n+1^{th} frame group period FGPn+1 including successive first to tenth frame periods FP1-FP10 following the n^{th} frame group period FGPn ends, the average degradation data calculator 250 may calculate n+1^{th} average degradation data ADDn+1 based on the degradation data DD1-DD10 with respect to the frame periods FP1-FP10 included in the n+1^{th} frame group period FGPn+1.

The age data calculator 220 may calculate the age data AD by accumulating the average degradation data ADD. The age data AD may include age values with respect to the pixels PX. In an embodiment, after the end of the n+1^{th} frame group period FGPn+1, the age data calculator 220 may read the age data AD stored after the end of the n^{th} frame group period FGPn from the internal age memory 230, may calculate the age data AD by adding the average degradation data ADD with respect to the frame periods FP1-FP10 included in the n+1^{th} frame group period FGPn+1 to the read age data AD, and may write the calculated age data AD to the internal age memory 230.

The internal age memory 230 may store the age data AD calculated by the age data calculator 220. The internal age memory 230 may provide the age data AD to the age data calculator 220 and the data compensator 240.

The data compensator 240 may generate the output image data OID by compensating the input image data IDD using the age data AD. In an embodiment, the data compensator 240 may include a compensation lookup table that stores compensation coefficients according to grayscale values and age values, may determine the compensation coefficients with respect to the pixels PX corresponding to the grayscale values included in the input image data IID and the age values included in the age data AD from the compensation lookup table, and may generate the output image data OID by applying the compensation coefficients with respect to the pixels PX to the input image data IID.

In an embodiment, during the frame periods FP1-FP10 included in the n+1^{th} frame group period FGPn+1, the data compensator 240 may read the age data AD stored after the end of the n^{th} frame group period FGPn from the internal age memory 230, and may generate the output image data OID by compensating the input image data IDD input in the frame periods FP1-FP10 included in the n+1^{th} frame group period FGPn+1 using the read age data AD.

In comparative examples, when degradation data with respect to the same predetermined frame period among successive frame periods FP1-FP10 is accumulated, age data with respect to the pixels PX may not be accurately calculated. In a comparative example, when the display device 100 is driven by the BFI method illustrated in FIG. 3 and the age data with respect to the pixels PX is generated by accumulating degradation data DD1 with respect to the first frame period FP1 among the successive frame periods FP1-FP10, the degradation data DD1 with respect to the active frame period AFP may be accumulated, so that age values included in the age data with respect to the pixels PX may be excessively greater than actual ages of the pixels PX. In another comparative example, when the display device 100 is driven by the BFI method illustrated in FIG. 3 and the age data with respect to the pixels PX is generated by accumulating degradation data DD2 with respect to the second frame period FP2 among the successive frame periods FP1-FP10, the degradation data DD2 with respect to the black frame period BFP may be accumulated, so that age values included in the age data with respect to the pixels PX may be excessively less than actual ages of the pixels PX.

However, in the embodiment described with reference to FIGS. 4 and 5, when the display device 100 is driven by the BFI method illustrated in FIG. 3, the age data AD with respect to the pixels PX may be generated by accumulating the average degradation data ADD that is an average of the degradation data DD1-DD10 with respect to the successive frame periods FP1-FP10, so that the age data DD may be generated by accumulating an average of the degradation data DD1, DD3, DD5, DD7, and DD9 with respect to the active frame period AFP and the degradation data DD2, DD4, DD6, DD8, and DD10 with respect to the black frame period BFP. Accordingly, the age values included in the age data AD with respect to the pixels PX may be accurately calculated.

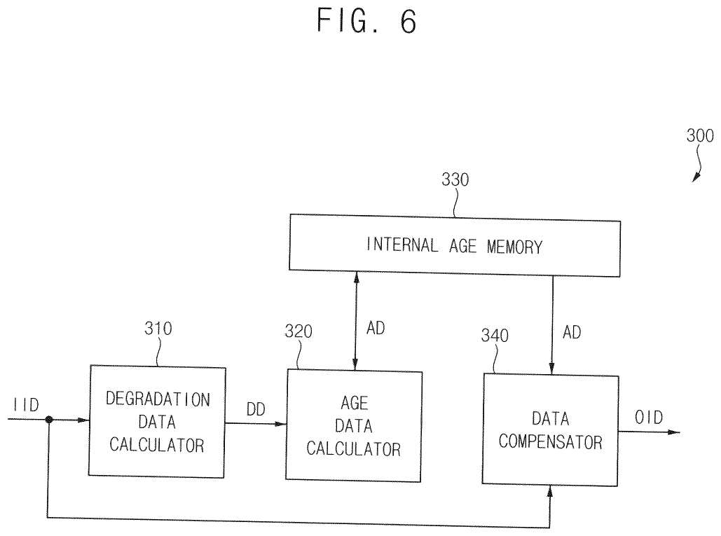

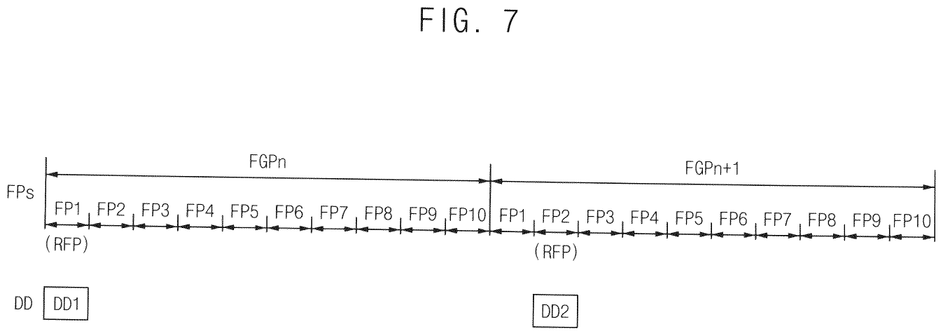

FIG. 6 is a block diagram illustrating an image sticking compensator 300 according to another embodiment. The image sticking compensator 300 in FIG. 6 may be another example of the image sticking compensator 150 included in the display device 100 in FIG. 1. FIG. 7 is a diagram for describing an operation of the image sticking compensator 300 in FIG. 6.

Descriptions of components of the image sticking compensator 300 described with reference to FIGS. 6 and 7, which are substantially the same as or similar to components of the image sticking compensator 200 described with reference to FIGS. 4 and 5, will be omitted.

Referring to FIGS. 6 and 7, the image sticking compensator 300 may generate the age data AD with respect to the pixels PX by accumulating degradation data DD with respect to a representative frame period RFP among the successive frame periods FPs, and may generate the output image data OID by compensating the input image data IID using the age data AD. The successive frame periods FPs may include an even number of frame periods. FIG. 7 illustrates an embodiment in which the successive frame periods FPs include 10 frame periods FP1-FP10, but the present disclosure is not limited thereto, and in another embodiment, the successive frame periods FPs may include an even number of frame periods which is less than or greater than 10. The image sticking compensator 300 may include a degradation data calculator 310, an age data calculator 320, an internal age memory 330, and a data compensator 340.

The degradation data calculator 310 may calculate the degradation data DD with respect to the representative frame period RFP among the successive frame periods FPs based on the input image data IID. In an embodiment, the degradation data calculator 310 may calculate the degradation data DD with respect to the representative frame period RFP by applying degradation weight data to the input image data IID.

In an embodiment, the representative frame period RFP may be randomly selected. In such an embodiment, the degradation data calculator 310 may randomly select one frame period as the representative frame period RFP for each frame group period including the successive frame periods FPs.

In another embodiment, the representative frame period RFP may be selected in a predetermined order. In such another embodiment, the degradation data calculator 310 may include a frame order lookup table that stores a frame order for determining the representative frame period RFP, and may select one frame period as the representative frame period RFP for each frame group period including the successive frame periods FPs using the frame order stored in the frame order lookup table. The frame order may be determined such that different frame period may be selected as the representative frame period RFP for each frame group period. For example, when each frame group period includes the first to tenth frame periods FP1-FP10, the frame order may be determined such that the first to tenth frame periods FP1-FP10 may be sequentially selected as the representative frame period RFP for each frame group period.

In an embodiment, during the n^{th} frame group period FGPn including successive first to tenth frame periods FP1-FP10, the degradation data calculator 310 may calculate the degradation data DD1 with respect to one representative frame period FP1 among the frame periods FP1-FP10 included in the n^{th} frame group period FGPn. Further, during the n+1^{th} frame group period FGPn+1 including successive first to tenth frame periods FP1-FP10 after the n^{th} frame group period FGPn, the degradation data calculator 310 may calculate the degradation data DD2 with respect to one representative frame period FP2 among the frame periods FP1-FP10 included in the n+1^{th} frame group period FGPn+1. FIG. 7 illustrates an embodiment in which the degradation data calculator 310 calculates the degradation data DD1 with respect to the first frame period FP1 during the n^{th} frame group period FGPn and calculates the degradation data DD2 with respect to the second frame period FP2 during the n+1^{th} frame group period FGPn+1, however, the present disclosure is not limited thereto, and the degradation data calculator 310 may randomly select the representative frame period RFP or may select the representative frame period RFP in a predetermined order for each frame group period, and may calculate the degradation data DD with respect to the selected representative frame period RFP.

The age data calculator 320 may calculate the age data AD by accumulating the degradation data DD with respect to the representative frame period FRP. In an embodiment, during the n+1^{th} frame group period FGPn+1, the age data calculator 320 may read the age data AD stored during the n^{th} frame group period FGPn from the internal age memory 330, may calculate the age data AD by adding the degradation data DD with respect to the representative frame period RFP among the frame periods FP1-FP10 included in the n+1^{th} frame group period FGPn+1 to the read age data AD, and may write the calculated age data AD to the internal age memory 330.

The internal age memory 330 may store the age data AD calculated by the age data calculator 320. The internal age memory 330 may provide the age data AD to the age data calculator 320 and the data compensator 340.

The data compensator 340 may generate the output image data OID by compensating the input image data IDD using the age data AD.

In an embodiment, during the frame periods FP1-FP10 included in the n+1^{th} frame group period FGPn+1, the data compensator 340 may read the age data AD stored during the n^{th} frame group period FGPn from the internal age memory 330, and may generate the output image data OID by compensating the input image data IDD input in the frame periods FP1-FP10 included in the n+1^{th} frame group period FGPn+1 using the read age data AD.

In the embodiment described with reference to FIGS. 6 and 7, when the display device 100 is driven by the BFI method illustrated in FIG. 3, the age data AD with respect to the pixels PX may be generated by accumulating the degradation data DD with respect to one representative frame period RFP among the successive frame periods FP1-FP10, so that the age data DD may be generated by accumulating the degradation data DD1, DD3, DD5, DD7, and DD9 with respect to the active frame period AFP and the degradation data DD2, DD4, DD6, DD8, and DD10 with respect to the black frame period BFP. Accordingly, the age values included in the age data AD with respect to the pixels PX may be accurately calculated.

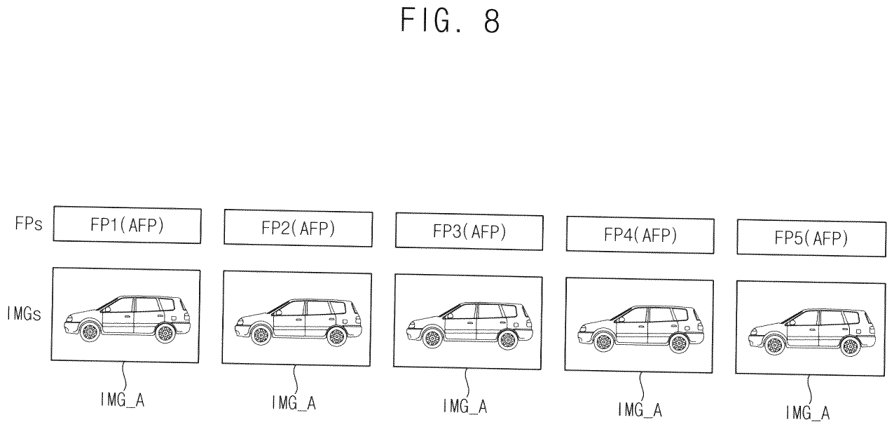

FIG. 8 is a diagram for describing images IMGs displayed in frame periods FPs according to an embodiment.

Referring to FIG. 8, according to an embodiment, the image display period of the display device 100 may include only the active frame periods AFP displaying the active image IMG_A. In other words, the display device 100 may not be driven by the BFI method described with reference to FIG. 3. For example, as illustrated in FIG. 8, the first to fifth frame periods FP1-FP5 may be the active frame periods AFP.

When the successive frame periods FPs include only the active frame periods AFP, the image refresh rate of the display device 100 may be equal to the driving frequency of the display device 100. For example, when the driving frequency of the display device 100 is 120 Hz, the image refresh rate of the display device 100 may be 120 Hz.

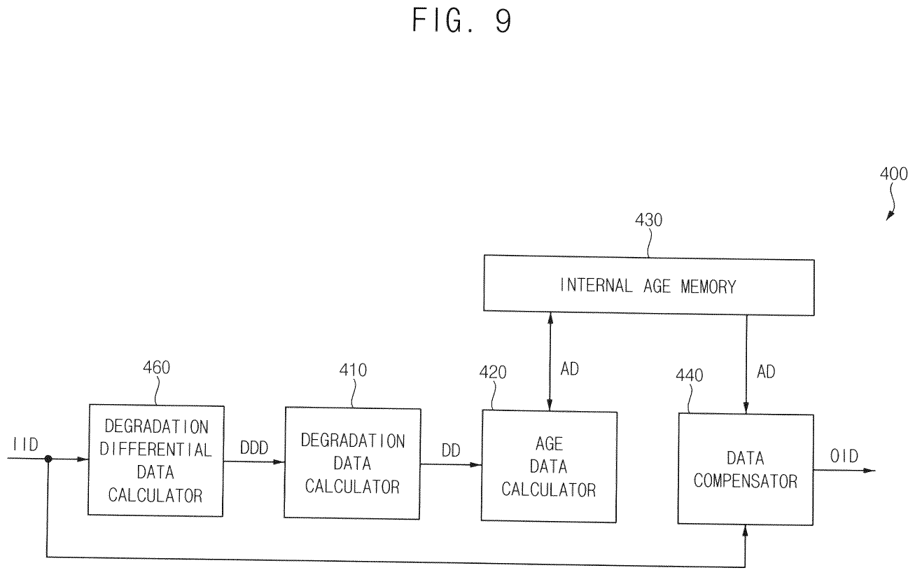

FIG. 9 is a block diagram illustrating an image sticking compensator 400 according to still another embodiment. The image sticking compensator 400 in FIG. 9 may be still another example of the image sticking compensator 150 included in the display device 100 in FIG. 1.

Descriptions of components of the image sticking compensator 400 described with reference to FIG. 9, which are substantially the same as or similar to components of the image sticking compensator 200 described with reference to FIGS. 4 and 5 or components of the image sticking compensator 300 described with reference to FIGS. 6 and 7, will be omitted.

Referring to FIG. 9, the image sticking compensator 400 may generate the degradation data DD by accumulating degradation differential data DDD with respect to two successive frame periods, may generate the age data AD with respect to the pixels PX by accumulating the degradation data DD, and may generate the output image data OID by compensating the input image data IID using the age data AD. The image sticking compensator 400 may include a degradation differential data calculator 460, a degradation data calculator 410, an age data calculator 420, an internal age memory 430, and a data compensator 440.

The degradation differential data calculator 460 may calculate the degradation differential data DDD with respect to two successive frame periods based on the input image data IID. In an embodiment, the degradation differential data calculator 460 may calculate the degradation differential data DDD based on a difference between the input image data IID in a first frame period among the two successive frame periods and the input image data IID in a second frame period among the two successive frame periods. The degradation differential data calculator 460 may include an internal image data memory for storing the input image data IID in the first frame period, and may calculate the degradation differential data DDD based on the difference between the input image data IID in the second frame period and the input image data IID in the first frame period during the second frame period.

The degradation data calculator 410 may calculate the degradation data DD by accumulating the degradation differential data DDD. In an embodiment, the degradation data calculator 410 may include an internal degradation memory for storing degradation data DD with respect to the first frame period, and may calculate the degradation data DD with respect to the second frame period by adding the degradation differential data DDD provided from the degradation differential data calculator 460 to the degradation data DD with respect to the first frame period stored in the internal degradation memory during the second frame period.

The age data calculator 420 may calculate the age data AD by accumulating the degradation data DD. In an embodiment, during the second frame period, the age data calculator 420 may read the age data AD stored during the first frame period from the internal age memory 430, may calculate the age data AD by adding the degradation data DD with respect to the second frame period to the read age data AD, and may write the calculated age data AD to the internal age memory 430.

The internal age memory 430 may store the age data AD calculated by the age data calculator 420. The internal age memory 430 may provide the age data AD to the age data calculator 420 and the data compensator 440.

The data compensator 440 may generate the output image data OID by compensating the input image data IDD using the age data AD.

In an embodiment, during the second frame period, the data compensator 440 may read the age data AD stored during the first frame period from the internal age memory 430, and may generate the output image data OID by compensating the input image data IDD input in the second frame period using the read age data AD.

When the display device 100 is driven by a method of not inserting the black frame illustrated in FIG. 8, the change of input images between adjacent frame periods may be small, and accordingly, the difference of the input image data IID between adjacent frame periods may be small. In this case, if the degradation data DD is calculated from the input image data IID for each frame period, the cost and time for calculating the age data AD with respect to the pixels PX may increase.

In the embodiment described with reference to FIG. 9, when the display device 100 is driven by the method of not inserting the black frame illustrated in FIG. 8, the degradation data DD may be generated by accumulating the degradation differential data DDD with respect to two successive frame periods, and the age data AD with respect to the pixels PX may be generated by accumulating the degradation data DD, so that the degradation DD may not calculated from the input image data IID for each frame period. Accordingly, the cost and time for calculating the age data AD with respect to the pixels PX may be reduced.

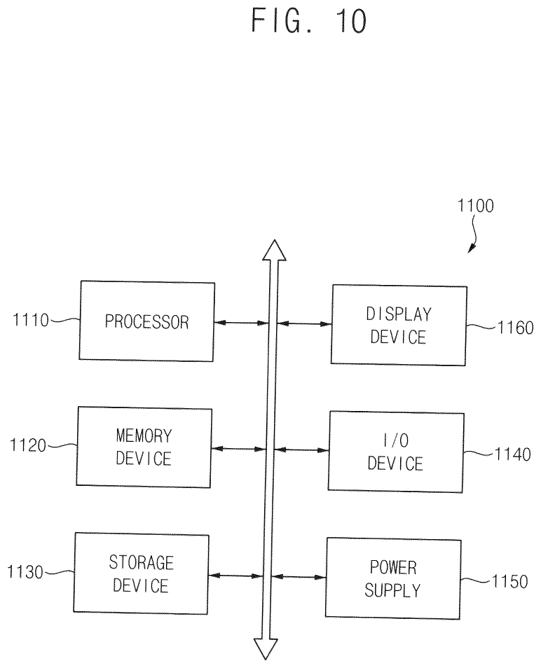

FIG. 10 is a block diagram illustrating an electronic apparatus 1100 including a display device 1160 according to an embodiment.

Referring to FIG. 10, the electronic apparatus 1100 may include a processor 1110, a memory device 1120, a storage device 1130, an input/output (“I/O”) device 1140, a power supply 1150, and a display device 1160. The electronic apparatus 1100 may further include a plurality of ports for communicating with a video card, a sound card, a memory card, a universal serial bus (“USB”) device, etc.

The processor 1110 may perform particular calculations or tasks. In an embodiment, the processor 1110 may be a microprocessor, a central processing unit (“CPU”), or the like. The processor 1110 may be coupled to other components via an address bus, a control bus, a data bus, or the like. In an embodiment, the processor 1110 may be coupled to an extended bus such as a peripheral component interconnection (“PCI”) bus. Here, the degradation data calculator, the average degradation data calculator, the age data calculator, the data compensator and the degradation differential data calculator may be implemented as the processor 1110, hardware, software, or firmware, for example, implemented in a form of an application-specific integrated circuit (ASIC).

The memory device 1120 may store data for operations of the electronic apparatus 1100. In an embodiment, the memory device 1120 may include anon-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, etc., and/or a volatile memory device such as a dynamic random access memory (“DRAM”) device, a static random access memory (“SRAM”) device, a mobile DRAM device, etc. The internal age memory may be implemented as the memory device 1120.

The storage device 1130 may include a solid state drive (“SSD”) device, a hard disk drive (“HDD”) device, a CD-ROM device, or the like. The I/O device 1140 may include an input device such as a keyboard, a keypad, a touchpad, a touch-screen, a mouse device, etc., and an output device such as a speaker, a printer, etc. The power supply 1150 may supply a power required for the operation of the electronic apparatus 1100. The display device 1160 may be coupled to other components via the buses or other communication links.

In the display device 1160, the age data with respect to the pixels may be generated by accumulating the average of the degradation data with respect to the plurality of successive frame periods, by accumulating the degradation data with respect to the representative frame period among the plurality of successive frame periods, or by accumulating the degradation differential data with respect to two successive frame periods, so that the age data may be accurately calculated using relatively small amount of degradation data, and the image sticking of the display device due to degradation of the pixels may be effectively improved.

The display device according to the embodiments may be applied to a display device included in a computer, a notebook, a mobile phone, a smart phone, a smart pad, a PMP, a PDA, an MP3 player, or the like.

Although the display devices according to the embodiments have been described with reference to the drawings, the illustrated embodiments are examples, and may be modified and changed by a person having ordinary knowledge in the relevant technical field without departing from the technical spirit described in the following claims.

What is claimed is:

1. A display device, comprising:
a display panel including a plurality of pixels; and
an image sticking compensator, which generates age data with respect to the plurality of pixels by accumulating average degradation data that is an average of degradation data with respect to a plurality of successive frame periods, and generates output image data by compensating input image data using the age data.

2. The display device of claim 1, wherein the plurality of successive frame periods include active frame periods displaying an active image and black frame periods alternating with the active frame periods and displaying a black image.

3. The display device of claim 1, wherein the plurality of successive frame periods include an even number of frame periods.

4. The display device of claim 1, wherein the image sticking compensator includes:
a degradation data calculator, which calculates the degradation data with respect to the plurality of successive frame periods based on the input image data;
an average degradation data calculator, which calculates the average degradation data based on the degradation data;
an age data calculator, which calculates the age data by accumulating the average degradation data;
an internal age memory, which stores the age data; and
a data compensator, which compensates the input image data using the age data.

5. The display device of claim 1, further comprising:
a gate driver, which provides gate signals to the plurality of pixels;
a data driver, which provides data signals generated based on the output image data to the plurality of pixels; and
a timing controller, which controls the gate driver and the data driver,
wherein the timing controller includes the image sticking compensator.

6. The display device of claim 1, further comprising:
an external memory, which stores the age data during a power-off of the display device.

7. A display device, comprising:
a display panel including a plurality of pixels; and
an image sticking compensator, which generates age data with respect to the plurality of pixels by accumulating degradation data with respect to a representative frame period among a plurality of successive frame periods, and generates output image data by compensating input image data using the age data.

8. The display device of claim 7, wherein the representative frame period is randomly selected.

9. The display device of claim 7, wherein the representative frame period is selected in a predetermined order.

10. The display device of claim 7, wherein the plurality of successive frame periods include active frame periods displaying an active image and black frame periods alternating with the active frame periods and displaying a black image.

11. The display device of claim 7, wherein the plurality of successive frame periods include an even number of frame periods.

12. The display device of claim 7, wherein the image sticking compensator includes:
a degradation data calculator, which calculates the degradation data with respect to the representative frame period based on the input image data;
an age data calculator, which calculates the age data by accumulating the degradation data;
an internal age memory, which stores the age data; and
a data compensator, which compensates the input image data using the age data.

13. The display device of claim 7, further comprising:
a gate driver, which provides gate signals to the plurality of pixels;
a data driver, which provides data signals generated based on the output image data to the plurality of pixels; and
a timing controller, which controls the gate driver and the data driver,
wherein the timing controller includes the image sticking compensator.

14. The display device of claim 7, further comprising:
an external memory, which stores the age data during a power-off of the display device.

15. A display device, comprising:
a display panel including a plurality of pixels; and
an image sticking compensator, which generates degradation data by accumulating degradation differential data with respect to two successive frame periods, generates age data with respect to the plurality of pixels by accumulating the degradation data, and generates output image data by compensating input image data using the age data.

16. The display device of claim 15, wherein the image sticking compensator includes:
a degradation differential data calculator, which calculates the degradation differential data based on the input image data;
a degradation data calculator, which calculates the degradation data by accumulating the degradation differential data;
an age data calculator, which calculates the age data by accumulating the degradation data;
an internal age memory, which stores the age data; and
a data compensator, which compensates the input image data using the age data.

17. The display device of claim 16, wherein the degradation differential data calculator calculates the degradation differential data based on a difference between the input image data in a first frame period of the two successive frame periods and the input image data in a second frame period of the two successive frame periods.

18. The display device of claim 17, wherein the degradation data calculator calculates the degradation data with respect to the second frame period by adding the degradation differential data to the degradation data with respect to the first frame period.

19. The display device of claim 15, further comprising:
a gate driver, which provides gate signals to the plurality of pixels;
a data driver, which provides data signals generated based on the output image data to the plurality of pixels; and
a timing controller, which controls the gate driver and the data driver,
wherein the timing controller includes the image sticking compensator.

20. The display device of claim 15, further comprising:
an external memory, which stores the age data during a power-off of the display device.
